(19) United States
(12) Patent Application Publication
(10) Pub. No.: US 2007/0010272 A1
(43) Pub. Date: Jan. 11, 2007

(54) Gateway between a push-to-talk type network and a second telecommunications network

(75) Inventors: Julien Calviac, Paris (FR); Philippe Bellordre, Paris (FR)

Correspondence Address: COHEN, PONTANI, LIEBERMAN & PAVANE LLP, Suite 1210, 551 Fifth Avenue, New York, NY, 10176, US

(73) Assignee: France Telecom, Paris (FR)

(21) Appl. No.: 11/472,156

(22) Filed: Jun. 21, 2006

(30) Foreign Application Priority Data
Jun. 22, 2005 (FR) 05 06319

(51) Int. Cl. H04B 7/00; H04Q 7/20

(52) U.S. Cl. 455/518

(57) ABSTRACT

This gateway includes means for creating a first instance of a first push-to-talk client adapted to communicate with a second push-to-talk client via a first telecommunications network; means for setting up a call with a service provider on a second telecommunications network; and control means adapted to set up a first communications channel between the first instance of the first push-to-talk client and the communications means to set up a logical session between a second push-to-talk client and the service provider.

### BACKGROUND OF THE INVENTION

The present invention lies in the field of push-to-talk (PTT) type services, which can be deployed on fixed or mobile telecommunications networks.

Push-to-talk services exchange messages within a group of users sharing a common communications channel. This is known in the art.

In practice, each member of the group has a telecommunications device adapted to receive and to send signals on the shared channel.

That device is designed to be in a receiving state by default. A user wishing to send on the shared channel operates a button to switch their terminal to send mode, like a walkie-talkie. The user can then send data (voice, video or any other media accepted by the service) on the shared channel, this data being communicated to the other members of the group.

The shared communications channel thus constitutes a half-duplex type communications channel.

In the past, operators have developed proprietary push-to-talk services.

Recently, work towards standardization has been carried out by the OMA (Open Mobile Alliance) under the OMA-POC V1 banner (PoC signifying “PTT over Cellular”), with a view to standardizing push-to-talk type services on mobile networks such as GSM (Global System for Mobile communications), UMTS (Universal Mobile Telecommunication System), and IMS (IP Multimedia System) networks, for example.

The PoC standard thus enables a group of users on a mobile access network (GSM, UMTS) normally developed to enable person-to-person communications via dedicated virtual communications channels to share a virtual communications channel.

However, the push-to-talk type services currently known in the art or in the process of standardization are instantaneous interpersonal communications services.

In particular, those services cannot connect a push-to-talk type user to a service provider.

A fortiori, they do not enable a service provider to push information to push-to-talk service users.

### OBJECT AND SUMMARY OF THE INVENTIONS

The main object of the present invention is to alleviate the above-mentioned drawbacks.

To this end, the invention provides a gateway device including:
means for creating a first instance of a first push-to-talk client adapted to set up a push-to-talk session with at least one second push-to-talk client via a first telecommunications network;
means for setting up a call with a service provider on a second telecommunications network which is of Internet type; and
control means adapted to set up a first communications channel between the first instance of the first push-to-talk client and the communications means to set up a logical session between said at least one second push-to-talk client and the service provider.

Thus the gateway device of the invention is used-to set up-a call between a push-to-talk client and a service provider.

That call may be initiated either by the push-to-talk user or by the service provider.

The control means of the gateway device of the invention are preferably adapted:
to detect breaking off of the push-to-talk session;
to initiate the creation of at least one second instance of the first push-to-talk client;
to set up a second push-to-talk session between the second instance of the first push-to-talk client and the second push-to-talk client; and
to set up a second communications channel between the second instance of the first push-to-talk client and the communications means to maintain the logical session between the second push-to-talk client and the service provider.

This feature is highly advantageous in that it enables a logical session to be maintained between the second push-to-talk client and the service provider that allows the service provider to provide its service in full and in a manner that is transparent to the second push-to-talk client, even if the push-to-talk session set up between the first and second push-to-talk clients is broken off.

Indeed, if the call between the two push-to-talk clients is broken off during a session, for example because of a time-out inherent to the push-to-talk service, the control means of the invention take the initiative to reconnect the two push-to-talk clients in a manner that is transparent for the user of the second push-to-talk client to allow the routing of the data necessary for the completeness of the service requested.

In a preferred embodiment of the invention the second telecommunications network is an Internet type network. In this case, the means for setting up a call with the service provider may consist of an instance of an IP (Internet Protocol) client.

In this embodiment, the control means maintain the above session if the call between the service provider and the instance of the IP client is broken off. To this end, the control means are adapted:
to detect breaking off of the call;
to initiate the creation of a second instance of the IP client;
to set up a third communications channel between the first or the second instance of the first push-to-talk client and the second instance of the IP client to maintain the logical session between said at least one second push-to-talk client and the service provider.

The gateway device of the invention preferably includes conversion means adapted:
to convert data received by the first push-to-talk client into a format compatible with the service provider; and
to convert data received by the communications means into a format compatible with the push-to-talk session.

If the push-to-talk session supports only voice messages, the conversion means include a voice recognition and voice synthesis engine, for example.

Thus a preferred use of the gateway of the invention is to extract text data from a web page received from a service provider, convert that text data into a voice stream, and transmit that voice stream to the user of the second push-to-talk client via the first push-to-talk client.

Conversely, the gateway may be used to convert a voice or DTMF response received from the second push-to-talk client into text data compatible with the service provider.

A preferred embodiment of the gateway device of the invention includes means for updating, via the gateway, a directory containing a list of the services accessible from the second client, the directory including at least one item of information sufficient to enable the gateway to identify the address of a service provider.

The directory, for example hosted by a server, is preferably accessed by a corresponding client of the terminal hosting the second push-to-talk client, for example a GSM type mobile terminal.

If the user wishes to access a service, he connects to the directory to obtain a list of the providers of that service.

The user contacts the gateway of the invention by operating a button provided for this purpose (or by means of a URL-type link) and the gateway sets up a logical session with the selected service provider.

A preferred embodiment of the gateway of the invention includes means for obtaining presence information and/or availability information in respect of a second push-to-talk client on the first telecommunications network.

The gateway of the invention advantageously uses the presence and availability information to contact a user who is present and to connect him to a predetermined service provider.

The invention also provides a control unit including means for setting up a communications channel between:
an instance of a push-to-talk client adapted to set up a push-to-talk session with a second push-to-talk client on a telecommunications network; and
means for communicating with a service provider on a second telecommunications network to set up or maintain a logical session between the second push-to-talk client and the service provider.

The control unit may either constitute the control means of the gateway device mentioned above or be implemented in an independent device.

In corresponding manner, the invention provides a method of setting up a call by at least one second push-to-talk client on a first telecommunications network with a service provider on a second telecommunications network, said method being adapted to be implemented in the above gateway and including:
a step of creating, within the gateway, a first instance of a first push-to-talk client adapted to set up a push-to-talk session with said at least one second push-to-talk client via the first telecommunications network;
a step of setting up a call between communications means of the gateway and the service provider on the second telecommunications network; and
a step of setting up a first communications channel between the first instance of the first push-to-talk client and the communications means to set up a logical session between said at least one second push-to-talk client and the service provider.

In a preferred implementation of the invention, the steps of the method are defined by instructions of a computer program.

Consequently, the invention also provides a computer program on an information medium, that program being adapted to be executed in a gateway computer and including instructions adapted to execute the above method.

The program may use any programming language and be in the form of source code or object code or in an intermediate form between source code and object code, such as a partially compiled form, or in any other desirable form.

The invention also provides an information medium readable by a gateway computer and containing instructions of a computer program of the above kind.

The information medium may be any entity or device capable of storing the program. For example, the medium may comprise a storage medium, such as a ROM, for example a CD-ROM or a microelectronic circuit ROM, or magnetic storage means, for example a diskette (floppy disk) or a hard disk.

Moreover, the information medium may be a transmissible medium such as an electrical or optical signal, which may be carried by an electrical or optical cable, by radio or by other means. The program of the invention may in particular be downloaded over an Internet type network.

Alternatively, the information medium may be an integrated circuit into which the program is incorporated and which is adapted to execute or to be used in the execution of the method in question.

### BRIEF DESCRIPTION OF THE DRAWINGS

Other features and advantages Of the present invention emerge from the description thereof given below with reference to the appended drawings, which show one nonlimiting embodiment of the invention. In the figures:

FIG. 1 is a diagram of a preferred embodiment of a gateway device conforming to the invention, and

FIG. 2 is a flowchart of the main steps of a preferred implementation of a communications method conforming to the invention.

### DETAILED DESCRIPTION OF ONE EMBODIMENT OF THE INVENTION

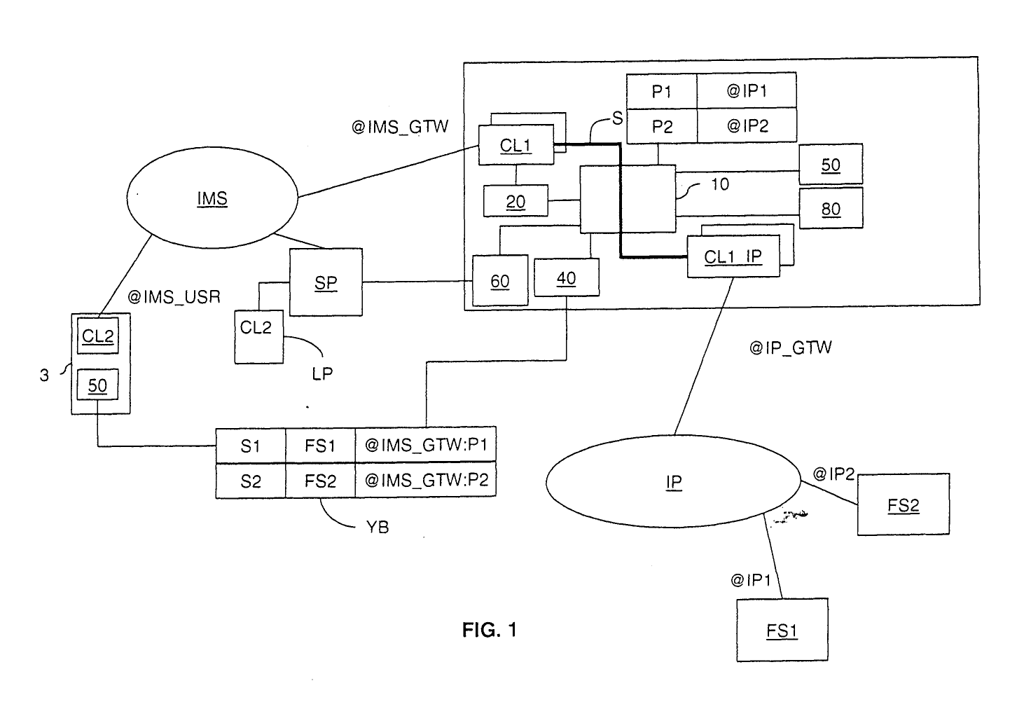

FIG. 1 shows a gateway 2 in accordance with the invention.

In this embodiment of the invention, the gateway 2 consists of a computer that includes conventional processing means 10 including a processor, a read-only memory for storing one or more computer programs, and a random-access memory for storing temporary variables used in the execution of the program(s).

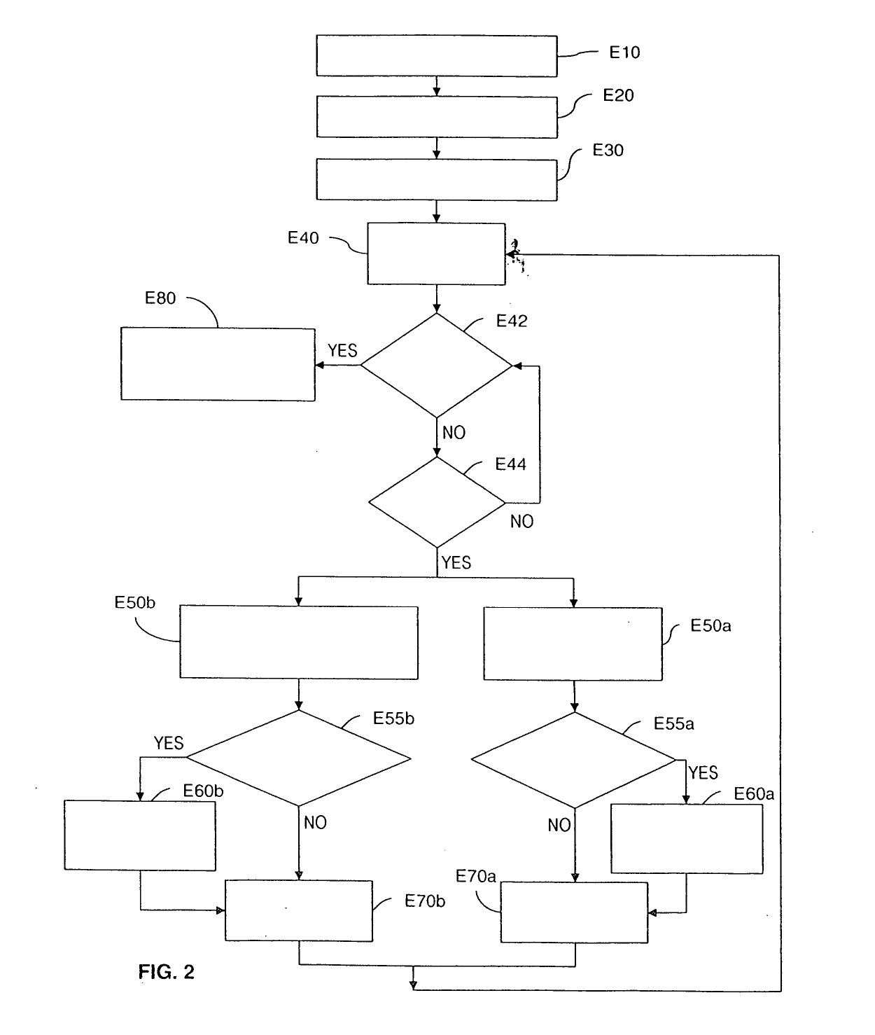

In accordance with the invention, the read-only memory of the gateway 2 stores a computer program including instructions for executing the steps of the method of the invention, FIG. 2 representing the main steps of the method in the form of a flowchart.

The gateway 2 enables the user of a terminal 3 subscribing to a push-to-talk type service to access services of providers FS1, FS2.

In the present example, the gateway more specifically enables the routing of data (audio, video, etc.) between the IP multimedia subsystem (IMS) on which the push-to-talk service is implemented and the IP network.

The following notation is used in this figure:
@IMS_USR is the address of the client terminal 3 on the IMS network;
@IMS_GTW is the address of the gateway 2 on the IMS network;
@IP1 and @IP2 are the addresses of the service providers FS1 and FS2 on the IP network; and
@IP_GTW is the address of the gateway 2 on the Internet network.

The terminal 3 of the user uses a push-to-talk client CL2 to access the push-to-talk service.

It is also assumed that the terminal 3 uses another client 50 to access a directory YB that contains a list of the services accessible via the push-to-talk service to which it subscribes.

In the present example, the directory YB contains entries for two service S1 and S2 respectively associated with a weather service (S1) and a stockmarket information service (S2), for example.

In the second column of the directory YB are the identities FS1 and FS2 of the providers able to provide the services S1 and S2.

In this preferred embodiment, the gateway 2 of the invention includes means 40 for updating the directory YB.

To be more precise, the means 40 store in the directory YB at least one item of information sufficient to enable the gateway 2 to identify the address of a service provider when the gateway is approached by the client CL2 of the user in respect of that service.

In the present example, it is assumed that the gateway 2 includes a memory 70 that associates two ports P1, P2 of the gateway 2 with the addresses @IP1 and @IP2 of the service providers FS1 and FS2. In this preferred embodiment, the means 40 for updating the directory YB respectively store the addresses @IMS_GTW:P1 and @IMS_GTW:P2 in the directory YB in association with the identities of the service providers FS1 and FS2.

The gateway 2 includes means 20 for creating instances of a push-to-talk client CL1 adapted to set up a push-to-talk session with the push-to-talk client CL2 of the terminal 3.

That client CL1 supports the posh-to-talk protocols used on the IMS network. It manages-push-to-talk sessions and all push-to-talk exchanges (voice, other media, and signaling).

The person skilled in the art will understand that if the push-to-talk service accepts multiple sessions an instance of the push-to-client client CL1 can take charge of one or more sessions with the same user as a function of the service.

The gateway 2 also includes means for setting up a call with the service providers FS1, FS2 on the IP telecommunications network.

In the present example, those call set-up means consist of an instance of an IP client known to the person skilled in the art.

A scenario in which the user of the terminal 3 wishes to access a weather service is described below.

To this end, using the client 50, the user looks up a weather service provider stored in the directory YB.

In the present example, the client 50 obtains the identity FS1 of the server of the same name. The user of the terminal 3 then presses a button of the terminal to access the weather service from the service provider FS1.

In practice, the push-to-talk client CL2 of the terminal 3 initiates a push-to-talk session on the IMS network with an instance of the push-to-talk client CL1 whose address on the IMS network, obtained from the directory YB, is @IMS_GTW:P1.

The processing means 10 of the gateway 2 obtain the port P1 from information on the push-to-talk session set up between the client CL2 of the terminal 3 and the client CL1 of the gateway 2.

The processor means 10 then read in the database 70 the Internet address @IP1 associated with the port P1. That address constitutes the address of the service provider FS1 that must be contacted to provide the weather service to the user of the terminal 3.

To this end, the processing means 10 include control means adapted to create an instance of an IP client CL1_IP for communicating via the IP network with the service provider FS1 at the address @IP1.

In this preferred embodiment, the gateway 2 of the invention also includes a database 80 that stores the media supported by the service providers FS1 and FS2.

In the present example, it is assumed that the service provider FS1 is adapted to deliver weather information in the form of HTML pages and to receive HTTP requests.

It is also assumed that the push-to-talk session set up between the client CL2 of the terminal 3 and the instance of the push-to-talk client CL1 of the gateway supports only audio streams.

In this preferred embodiment, the gateway 2 of the invention includes means 150 adapted:
to convert audio data received by its push-to-talk client CL1 into HTTP requests compatible with the service provider FS1, and
to convert HTML pages received by its IP client CL1_IP into audio data compatible with the client CL2 of the terminal 3.

Accordingly, when the client CL1_IP obtains the first HTML page from the service provider FS1, for example, that page containing names of towns for which the provider holds weather data, for example, the conversion means 150 convert those town names into an audio stream and send that audio stream to the push-to-talk client CL2 of the terminal 3 via the push-to-talk client CL1 of the gateway 2.

Conversely, in this embodiment, the conversion means 150 transcribe into text a voice stream that is received from the terminal 3 and consists here of an audio message representing the name of a town for which the user wishes to obtain weather data, for example.

One embodiment of the control leans 10 of the gateway device 2 conforming to the invention is described in detail below with reference to FIG. 2.

In the present example, these control means are implemented in the processor means 10 and are also identified by the reference number 10.

On receiving a call from the push-to-talk client CL2 of the terminal 3, during a step E10, the control means 10 create a first instance of a push-to-talk client CL1 for setting up a push-to-talk session with that client CL2.

After obtaining the IP address of the service provider FS1, during a step E20, the control means 10 create an instance of an IP client CL1_IP for communicating via the Internet network with that service provider FS1.

The control means 10 of the invention then set up, during a step E30, a communications channel S between the instance of the push-to-talk client CL1 and the instance of the IP client CL1_IP in order to set up a logical session between the client CL2 of the terminal 3 and the service provider FS1.

The person skilled in the art will understand that this communications channel S can carry data, if necessary converted by the conversion means 150.

It is assumed that in this preferred embodiment of the invention the control means 10 of the gateway 2 terminate this logical session if no frame is exchanged between the push-to-talk client CL2 and the service provider FS1 during a predetermined time

To this end, the step E30 of setting up the communications channel S is followed by a step E40 of initializing a countdown with this predetermined time.

That initialization step is followed by a step E42 in which the control means 10 verify if the countdown has expired.

If so, the test E42 is follower by a step E80 in which the control means 10 of the gateway 2 of the invention destroy the instances of the push-to-talk client CL1 and the IP client CL1_IP.

If the countdown has not yet expired, the result of the test E42 is negative.

That test is then followed by a test E44 in which the control means 10 verify if a frame has been received from the push-to-talk client CL2 or the service provider FS1.

If not, the result of this test E44 is negative. This test is then followed by the test E42 already described that verifies whether the countdown has expired.

If a frame has been received from the push-to-talk client CL2, i.e. by the push-to-talk client CL1 of the gateway 2, the test E44 is followed by a step E50a in which the audio stream received by the push-to-talk client CL1 is converted to text data adapted to the service provider FS1.

This conversion step E50a is followed by a step E55a in which the control means 10 test if the call set up between the IP client CL1_IP and the service provider FS1 has been broken off, for example the because of a time-out inherent to the HTTP protocol of the connection set up with the service provider FS1.

If so, this test E55a is followed by a step E60a in which the control means 10 initiate the creation of a second instance of the IP client CL1_IP and set up a communications channel between the still active push-to-client CL1 and this new instance of the IP client CL1_IP.

Thus the control means 10 advantageously maintains the session between the client CL2 of the terminal 3 and the service provider FS1 even if the IP session is broken off.

The data converted to test the format in the step E50a is then transferred in a step E70a to the service provider FS1.

This data transfer step is followed by the step E40 already described in which the control means 10 reset the countdown to the predetermined time.

The gateway 2 of the invention executes the equivalent process when a frame is received in the step E44 from the service provider FS1, i.e. by the IP client CL1_IP.

To be more precise, the control means 10 command (step E50b) the conversion means 150 to convert the HTML page into an audio stream that can be transported by the push-to-talk session set up between the client CL1 of the gateway 2 and the client CL2 of the terminal 3.

This conversion step E50b is followed by a step E55b in which the control means 10 of the gateway 2 verify if the push-to-talk session is still in progress.

This may in particular be the case if a time-out inherent to the push-to-talk service has expired.

If so, the control means 10 initiate the creation (step E60b) of a second instance of the push-to-talk client CL1 and set up a communications channel S between that second instance of the client CL1 and the still active instance of the IP client CL1_IP.

This step E60b of creating a new instance of the push-to-talk client is followed by a step E70b in which the audio stream obtained in the step E50b is sent to the push-to-talk client CL2 of the terminal 3.

This step E70b of sending the audio stream is followed by the step E40 already described of resetting the countdown to the predetermined time.

The present example describes in detail a scenario in which the client CL2 initiates the session by accessing the service provider FS1.

The person skilled in the art will understand that the gateway 2 of the invention may equally well be used in a mode in which a service provider FS1, FS2 spontaneously contacts a push-to-talk service user.

To this end, the gateway 2 of the invention preferably includes means 60 for determining if a push-to-talk client CL2 is available on the IMS telecommunications network.

In this preferred embodiment of the invention, the means 60 consist of a presence client adapted to contact a presence server SP connected to the IMS network.

This presence server SP is known in the art. It includes a presence list LP containing all of the identifiers of the push-to-talk client CL2 connected to the IMS network at a given time.

In a preferred embodiment of the invention, the means 60 also send to the presence server SP information representative of the presence and/or the availability of the services S1, S2 offered by the service providers FS1, FS2.

Accordingly, the person skilled in the art will understand that the means 60:
inform the service providers FS1, FS2 of the presence of push-to-talk clients so that the service provider can offer certain services to users, and
inform the push-to-talk clients of the presence of certain services so that users can spontaneously contact the providers giving access to those services.

In this embodiment, the IP client of the service provider, for example FS1, sets up a call with an instance of the IP client CL1_IP of the gateway 2. In this preferred embodiment, in which the second network R2 is the Internet network, that call is initiated by sending an HTTP request to the address @IP_GTW of the gateway 2, that request including the address @IMS_USR on the IMS network of the terminal 3 that wishes to contact the service provider.

On receipt of that request, the control means 10 of the gateway 2 create an instance of the first push-to-talk client CL1 to set up a push-to--talk session on the IMS network with the push-to-talk client CL2 of the terminal 3.

The control means 10 of the gateway 2 then set up a communications channel between the instance of the push-to-talk client CL1 and the instance of the IP client CL1_IP to set up a logical session between the service provider FS1 and the push-to-talk client CL2.

What is claimed is:

1. A gateway device including:
means for creating a first instance of a first push-to-talk client adapted to set up a push-to-talk session with at least one second push-to-talk client via a first telecommunications network;
means for creating an instance of an IP client to set up a call with a service provider on a second telecommunications network which is of Internet type; and
control means adapted to set up a first communications channel between said first instance of the first push-to-talk client and said communications means to set up and maintain a logical session between said at least one second push-to-talk client and said service provider.

2. A gateway device according to claim 1, wherein said control means are adapted:
to detect breaking off of said push-to-talk session;
to initiate the creation of a second instance of said first push-to-talk client;
to set up a second push-to-talk session between said second instance of said first push-to-talk client and said at least one second push-to-talk client; and
to set up a second communications channel between said second instance of the first push-to-talk client and said communications means to maintain said logical session between said at least one second push-to-talk client and said service provider.

3. A gateway device according to claim 1, wherein said control means are adapted:
to detect breaking off of the call between said service provider and said instance of the IP client;
to initiate the creation of at least one second instance of said IP client;
to set up a third communications channel between said first or said at least one second instance of the first push-to-talk client and said second instance of said IP client to maintain said logical session between said at least one second push-to-talk client and said service provider.

4. A gateway device according to claim 1, including conversion means adapted:
to convert data received by the first push-to-talk client into a format compatible with said service provider; and
to convert data received by the communications means into a format compatible with said push-to-talk session.

5. A gateway device according to claim 1, including means for updating a directory containing a list of the services accessible from said second push-to-talk client via said gateway, said directory including at least one item of information sufficient to enable said gateway to identify the address of a provider of said service.

6. A gateway device according to claim 1, including means for obtaining presence information and/or availability information in respect of a second push-to-talk client on said first telecommunications network.

7. A gateway device according to claim 1, including means for publishing the presence and/or the availability of the services offered by said service providers.

8. A control unit including means for setting up a communications channel between:
an instance of a push-to-talk client adapted to set up a push-to-talk session with a second push-to-talk client on a first telecommunications network; and
an instance of an IP client in communication with a service provider on a second telecommunications network which is of the Internet type,
so as to set up and maintain a logical session between the second push-to-talk client and the service provider.

9. A method of establishing communication of at least one second push-to-talk client on a first telecommunications network with a service provider on $ second telecommunications network which is -of the Internet type, said method being adapted to be implemented in a gateway according to claim 1 and including:
a step of creating, within said gateway, a first instance of a first push-to-talk client adapted to set up a push-to-talk session with said at least one second push-to-talk client via said first telecommunications network;
a step of setting up a call between an instance of an IP client of said gateway and said service provider on said second telecommunications network; and
a step of setting up a first communications channel between said first instance of the first push-to-talk client and said communications means to set up and maintain a logical session between said at least one second push-to-talk client and said service provider.

10. A computer program including instructions for executing steps of the method according to claim 9 when said program is executed by a computer.

11. A computer-readable storage medium which stores a computer program including instructions adapted to execute steps of the method according to claim 9 when said program is executed by a computer.
